(19) United States
(12) Patent Application Publication
(10) Pub. No.: US 2026/0138247 A1
(43) Pub. Date: May 21, 2026

(54) TORQUE WRENCHES EQUIPPED WITH DEVICES FOR DETECTING OBSTACLES AND/OR CORRECT GRIPS

(71) Applicant: ATLAS COPCO INDUSTRIAL TECHNIQUE AB, Stockholm (SE)

(72) Inventors: Paolo CHIARIOTTI, Filottrano (AN) (IT); Alfredo CIGADA, Milano (MI) (IT); Nicola GIULIETTI, Falconara Marittima (AN) (IT); Massimiliano CATTANEO, Carate Brianza (MB) (IT); Nicolò FIORETTI, Solaro (MI) (IT)

(21) Appl. No.: 19/121,475

(22) PCT Filed: Oct. 16, 2023
(86) PCT No.: PCT/IB2023/060417

§ 371 Date: Apr. 16, 2025

(30) Foreign Application Priority Data
Oct. 17, 2022 (IT) 102022000021342

(51) Int. Cl. B25B 23/142

(52) U.S. Cl. CPC B25B 23/1425

(57) ABSTRACT

A method of checking tightening by a torque wrench may include: a first phase for training of an artificial intelligence model; and a second phase for detecting tightening conditions on a basis of the trained artificial intelligence model. The wrench may include: a body, including control circuits, an electronic processing unit, a first end including a handle for gripping by an operator who performs the tightening, and a second end including an arm. A free end of the arm may include a seat configured to receive inserts configured to engage the wrench with a corresponding mechanical member on which the wrench is configured to perform tightening operations. The arm further may include sensors configured to detect the tightening conditions exerted on the mechanical member. The processing unit may be configured to communicate with the sensors. The processing unit may be further configured to receive data detected during the tightening.

The present invention relates to a torque wrench wherein it is possible to control the tightening torque exerted on the bolt to be tightened, and wherein there is a device suitable for detecting the presence of any obstacles that may be encountered when turning the wrench to perform a tightening operation. In addition, this wrench is also equipped with a device suitable for verifying the correct grip of the wrench by an operator during the aforesaid tightening operation.

Tightening tools, such as torque wrenches, are known in the state of the art which comprise a body, containing control circuits and an electronic processing unit having, at one end, a handle to be gripped by an operator, and an arm at the other end. Such an arm comprises at its free end a seat in which a plurality of inserts, suitable for engaging the tool with a corresponding type and/or size of a mechanical member on which the tool is intended to act, can be alternatively engaged to perform a tightening operation. Sensor means are provided on said arm suitable for detecting tightening conditions exerted on said mechanical member. From these sensor means, the signals are transferred to the central processing unit, which processes and simultaneously displays them, so that the tightening performed can be verified.

Patent EP2326464 describes a tool of this type in the form of a torque wrench, which comprises a body, containing the control circuits and processing unit of the wrench, at one end a handle (advantageously containing rechargeable batteries for powering the wrench) and on the other end an arm. Advantageously, a display for visualizing information and operating data is provided on the body and a wrenchboard allows data and commands to be entered. A tool head which must be coupled with the type of mechanical member (for example, the head of a screw, with male or female coupling) on which the wrench is intended to operate is inserted interchangeably in a special seat at the end of the arm.

The sensors which measure the torque to be exerted on the member to be tightened are placed on the arm and comprise at least one strain gauge, which is a sensor whose electrical resistance varies with the deformation it undergoes; so it converts the force, pressure, voltage, weight, etc., into a variation in electrical resistance that can be measured.

The value of the torque exerted is normally available on the wrench display or is indicated near it by means of special light and/or acoustic signals.

Patent Application EP4003656 describes a tool of this type comprising a body having an axial extension along a longitudinal axis, a front end equipped with a coupling intended to engage the wrench on a joint to be tightened by manual rotation about an axis of rotation that is transverse to the longitudinal axis, a handle along the body for manoeuvring the wrench. The wrench is equipped with a sensor to detect a torque applied to the coupling having two strain gauges spaced apart from each other along the longitudinal axis. An electronic control circuit receives signals from the sensors and, depending on the deflection values detected by the two sensor elements, possibly issues an error signal. In particular, if the deflection value detected by the sensor element closest to the front end is lower than the deflection value detected by the sensor element furthest from the front end, it emits this error signal. This is because, during normal tightening, the torque value detected by the sensor closest to the tool head of the wrench should normally be higher than that detected by the sensor closest to the handle. If this is not the case, an anomaly is signalled.

Patent Application EP4003655 describes the same type of wrench as Application EP4003656, wherein data processing from the two strain gauges is used to check whether the wrench has been correctly gripped. Specifically, the wrench processing unit calculates, based on deflection values measured by the two strain gauges, the point P along the longitudinal axis related to the application of the manual rotational force of the wrench and compares the position of the point P with predefined positions. If this point does not correspond with at least one of these positions, an error signal is issued.

The Applicant noted that the method of detecting the obstacle proposed by this Application EP4003655 only reveals the anomaly if the obstacle is located between the position of the sensors and the handle. In fact, under such conditions there is an inversion of the values measured by the strain gauges, whereas if the impact against the obstacle occurs in a portion of the wrench between the sensors and the tool head, this inversion of the detection values does not occur. In addition, by contrast, an increase in the tightening torque value is detected. Thus, in such a condition, an anomaly is not detected, the wrench validates the measurement, and this measurement is not correct, indicating a higher-value tightening torque than the one actually exerted.

Among other things, the impact with an obstacle placed close to the tool head is a frequent occurrence, for example when the bolt to be tightened is recessed in a housing and parts of that housing can impact against the wrench, or when the bolt to be tightened is surrounded by other bolts, such as in a flange.

One aspect of the present invention relates to a torque wrench having the characteristics of the enclosed claim 1.

Further objects and advantages of the present invention will become clear from the following description and from the attached drawings, provided purely by way of non-limiting example, in which:

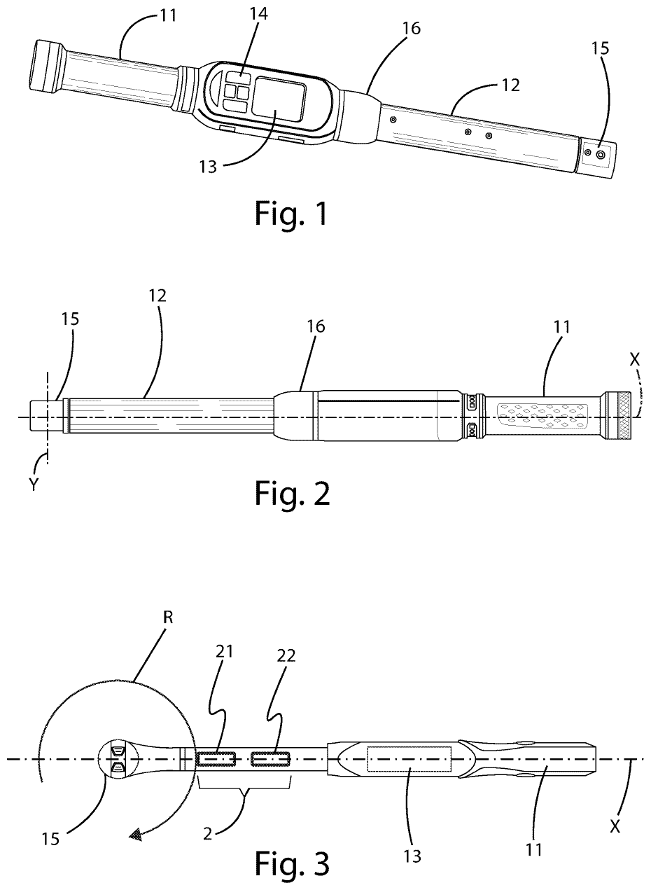

FIG. 1 is a perspective view of the tightening tool according to the present invention;

FIG. 2 is a front view of the tool of FIG. 1;

FIG. 3 is a top view of the wrench of FIG. 1 with the position of the strain gauges highlighted and the direction of rotation of a tightening indicated;

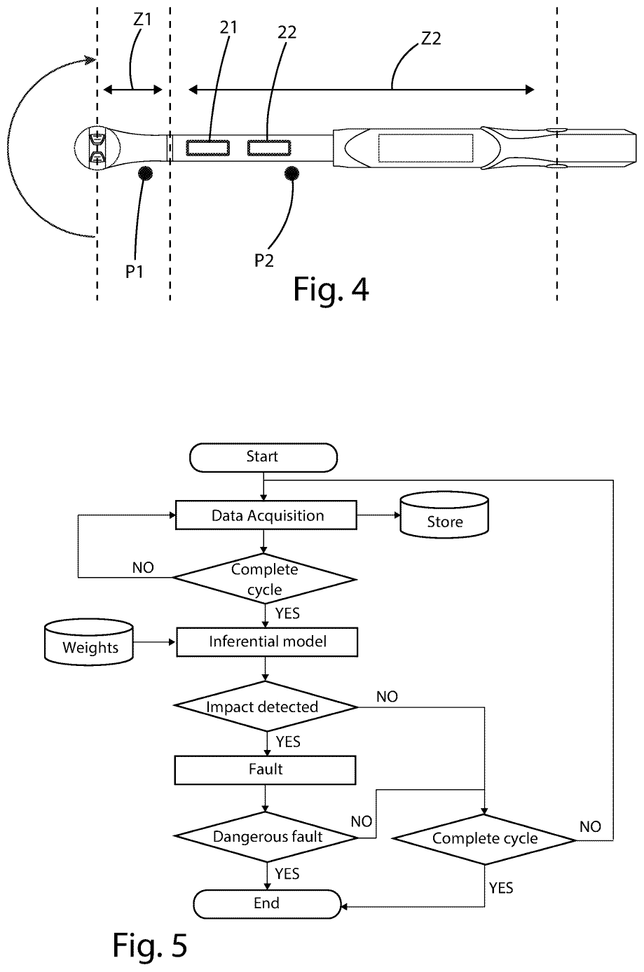

FIG. 4 is a view of the wrench of FIG. 3, wherein two obstacles in a position of possible collision with the wrench are highlighted;

FIG. 5 is a flow algorithm of an embodiment of the present invention of the detection method of the tightening conditions;

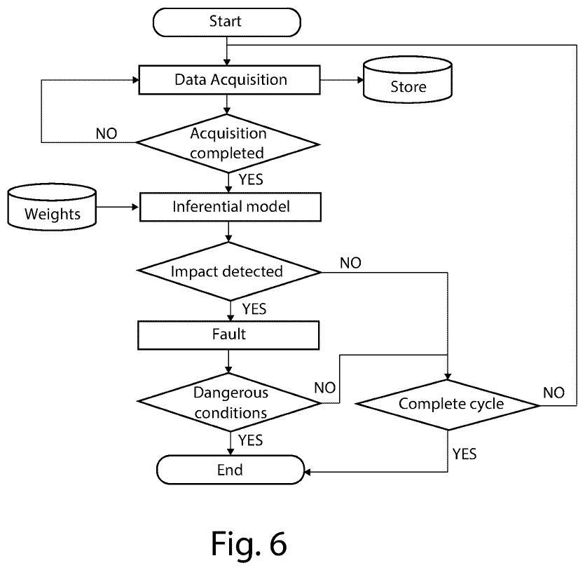

FIG. 6 is a flow algorithm of a further embodiment of the present invention of the detection method of the tightening conditions.

With reference to the aforementioned figures, the tightening torque wrench according to the present invention comprises a body containing electronic control circuits and a central processing unit having at one end of that body, along a longitudinal axis X of the tool, a handle 11 (preferably containing rechargeable batteries for powering the tool) and on the other end an arm 12, still on the same axis. Advantageously, a display 13 for visualizing information and operating data is advantageously provided and a wrenchboard 14 allows to enter data and commands.

Obviously, it is understood that if the processing or storage of data requires a unit which cannot be easily or completely contained in the body, the body can be connected, by means of a cable or a wireless connection, to external processing units. A wired connection can also be envisaged to provide external power supply.

At the end of the arm 12, a plurality of inserts can be alternatively engaged in a suitable seat 15. For example, each insert will be suitable for engaging the wrench with a corresponding type and/or size of mechanical member or element (screw, nut, etc.) on which the tool is intended to operate.

Although for simplicity's sake inserts having all a similar dimension are shown, elongated inserts or inserts with arms of particular shape can also be provided, as known in the art.

Each insert may comprise therein a transponder in a suitable position (typically in the shank engaging the seat) to couple with a suitable antenna close to the seat when it is mounted on the tool.

The coupling modes between transponder and antenna for the activation of the transponder (usually known as “tag”) and the communication are widely known and will therefore not be herein described in detail.

The wrench comprises sensor means 2 of the tightening conditions and an electronic processing unit that communicates with these sensor means and receives the data detected during the tightening.

For example, such sensor means comprise torque sensors exerted on the mechanical member, comprising a first 21 and a second strain gauge 22, arranged spaced apart from each other at predefined positions of the arm along the longitudinal axis of the arm 12.

Such sensor means further comprise angle sensors, e.g. whose detection values originate from gyroscopes, both in the longitudinal axis X of the wrench and in the rotation axis Y.

In general, there can be sensor means of any kinematic or dynamic magnitude of the tightening conditions.

According to the present invention, the wrench electronic processing unit acquires the detection values made by these sensor means and implements a method of checking the tightness comprising a step of training an artificial intelligence model and a step of detecting the tightening conditions on the basis of this trained model.

This training step involves performing a plurality of tightenings, wherein:
at least one wherein the impact against a first obstacle P1 occurs in a first zone Z1 between the tool head and the sensor means, preferably the first strain gauge 21,
at least one wherein the impact against a second obstacle P2 occurs in a second zone Z2 between the sensor means, preferably the second strain gauge 22, and the handle 11 of the wrench,
at least one in which there is no impact against obstacles and the tightening is carried out correctly.

The number of tightenings with impact and without impact must be a sufficient number such as to stabilise the model parameters.

Once the artificial intelligence model has been trained, each time an actual tightening is carried out, data is acquired from these sensor means and it is determined whether there has been an impact against an obstacle and if so, the anomaly is reported and the tightening is not validated.

The learning step of the model is for determining weights that determine the importance of the acquired data. Those with a higher value contribute more significantly to determining the output of the model.

A possible operating sequence of the method according to the present invention is shown in the flow algorithm in FIG. 5.

At the start of the tightening operations, the acquisition is actuated, preferably from all sensors comprised in the sensor means (i.e. torque, angle, strain gauges, and gyroscopes).

This acquired data is stored and provided as input to the inferential model, which, by means of the weights calculated in the model training step, determines whether an impact against an obstacle has been detected. In addition, it is detected if the magnitude of the anomaly is such as to invalidate the measurement of the tightening condition.

The proposed method does not depend on the impact zone and covers all possible impact cases (ZONE Z1 and ZONE Z2). Once an impact against an obstacle has been identified, the algorithm alerts the operator.

The algorithm is able to distinguish whether the obstacle is hit in a dangerous zone, resulting in an overestimation of the applied torque (ZONE Z1), or not.

This method may be applied not only to check whether the impact against an obstacle has occurred, but in general it can be applied to check the tightening conditions.

For example, it is possible to check whether the operator was gripping the wrench correctly during tightening.

In fact, an operator, due to distraction or lack of training, could carry out the tightening improperly and a wrong grip of the wrench could result in an wrong measurement of the torque applied to the joint.

Also in this case, the training step of the method involves performing at least one tightening with an incorrect grip and at least one with a correct grip.

The number of tightenings with correct and incorrect grip must be an appropriate number such to stabilise the model parameters.

A possible operating sequence of the method for checking the correct grip according to the present invention is shown in the flow algorithm in FIG. 5.

Also in this case, a neural model analyses the signal from the wrench on-board sensors and assesses whether or not a wrong handling event has occurred.

Once the wrong handling event has been identified, the algorithm alerts the operator. The algorithm is able to distinguish whether the wrong handling results in an overestimation of the applied torque or not.

1. A method of checking tightening by a torque wrench, the method comprising:
a first phase for training of an artificial intelligence model; and
a second phase for detecting tightening conditions on a basis of the trained artificial intelligence model;
wherein the torque wrench comprises:
a body, comprising control circuits and an electronic processing unit, the body having at a first end, a handle for gripping by an operator who performs the tightening, and at a second end, an arm;
wherein at a free end of the arm, the arm comprises a seat in which a plurality of inserts, suitable for engaging the torque wrench with a corresponding type and/or size of mechanical member on which the torque wrench is intended to act, can be alternatively engaged to perform tightening operations; and
wherein the arm further comprises sensor means suitable for detecting the tightening conditions exerted on the mechanical member;
wherein the electronic processing unit communicates with the sensor means and receives data detected during the tightening.

2. The method of claim 1, wherein the detecting of the tightening conditions comprises detection of possible impact against an obstacle during the tightening.

3. The method of claim 1, wherein the training of the artificial intelligence model comprises a plurality of tightenings:
at least one of the tightenings in which there is a first impact against a first obstacle in a first area between the free end of the arm and the sensor means;
at least one of the tightenings in which there is a second impact against a second obstacle in a second area between the sensor means and the handle; and
at least one of the tightenings in which there is no impact against an obstacle and the tightening is carried out correctly.

4. The method of claim 1, wherein the detecting of the tightening conditions comprises detecting a correct grip of the handle by the operator during the tightening.

5. The method of claim 4, wherein the training of the artificial intelligence model comprises at least one tightening with an incorrect grip of the handle by the operator during the tightening and at least one tightening with a correct grip of the handle by the operator during the tightening.

6. The method of claim 1, wherein the detecting of the tightening conditions comprises signaling of an anomaly if a collision with an obstacle is detected.

7. The method of claim 1, wherein the detecting of the tightening conditions comprises signaling of an anomaly if an incorrect grip of the of the handle by the operator during the tightening is verified.

8. The method of claim 1, wherein the sensor means comprises a first strain gauge and a second strain gauge spaced apart from each other in predefined positions of the arm along a longitudinal axis of the arm, and
angle sensors on both the longitudinal axis of the arm and on a rotation axis of the torque wrench.

9. A torque wrench, comprising:
a body, comprising control circuits and an electronic processing unit, the body having at a first end, a handle for gripping by an operator who performs tightening, and at a second end, an arm;
wherein at a free end of the arm, the arm comprises a seat in which a plurality of inserts, suitable for engaging the torque wrench with a corresponding type and/or size of mechanical member on which the torque wrench is intended to act, can be alternatively engaged to perform tightening operations,
wherein the arm further comprises sensor means suitable for detecting tightening conditions exerted on the mechanical member, and
wherein the sensor means communicates with the electronic processing unit which is configured to carry out the method of claim 1.

10. A method of checking tightening by a torque wrench, the method comprising:
a first phase for training of an artificial intelligence model; and
a second phase for detecting tightening conditions on a basis of the trained artificial intelligence model;
wherein the torque wrench comprises:
a body, comprising control circuits, an electronic processing unit, a first end comprising a handle for gripping by an operator who performs the tightening, and a second end comprising an arm;
wherein at a free end of the arm, the arm comprises a seat configured to receive a plurality of inserts, the inserts configured to engage the torque wrench with a corresponding type and/or size of mechanical member on which the torque wrench is configured to perform tightening operations,
wherein the arm further comprises sensors configured to detect the tightening conditions exerted on the mechanical member,
wherein the electronic processing unit is configured to communicate with the sensors, and
wherein the electronic processing unit is further configured to receive data detected during the tightening.

11. The method of claim 10, wherein the detecting of the tightening conditions comprises detection of possible impact against an obstacle during the tightening.

12. The method of claim 10, wherein the training of the artificial intelligence model comprises a plurality of tightenings:
at least one of the tightenings in which there is an impact against a first obstacle in a first area between the free end of the arm and the sensors;
at least one of the tightenings in which there is an impact against a second obstacle in a second area between the sensors and the handle; and
at least one of the tightenings in which there is no impact against an obstacle.

13. The method of claim 10, wherein the sensors comprise at least one torque sensor.

14. The method of claim 10, wherein the sensors comprise at least one strain gauge.

15. The method of claim 10, wherein the sensors comprise at least one angle sensor configured to detect angle values relative to a longitudinal axis of the arm.

16. The method of claim 10, wherein the sensors comprise at least one angle sensor configured to detect angle values relative to a rotational axis of the torque wrench.

17. The method of claim 10, wherein the sensors comprise at least one kinematic sensor.

18. The method of claim 10, wherein the sensors comprise at least one dynamic sensor.

19. The method of claim 10, wherein the detecting of the tightening conditions comprises detecting a correct grip of the torque wrench by the operator during the tightening.

20. The method of claim 10, wherein the training of the artificial intelligence model comprises:
at least one tightening with an incorrect grip of the torque wrench by the operator during the tightening; and
at least one tightening with a correct grip of the torque wrench by the operator during the tightening.
